(19) United States
(12) Patent Application Publication
(10) Pub. No.: US 2011/0254790 A1
(43) Pub. Date: Oct. 20, 2011

(54) TRANSPARENT ADHESIVE SHEET FOR FLAT PANEL DISPLAY AND FLAT PANEL DISPLAY

(75) Inventors: Tatsuya Suzuki, Osaka (JP); Tomohide Banba, Osaka (JP); Hiroaki Fumoto, Osaka (JP)

(73) Assignee: NITTO DENKO CORPORATION, Ibaraki-shi (JP)

(21) Appl. No.: 13/124,585

(22) PCT Filed: Oct. 16, 2009
(86) PCT No.: PCT/JP2009/067923

§ 371 Date: Jul. 5, 2011

(30) Foreign Application Priority Data
Oct. 17, 2008 (JP) 2008-268890

(51) Int. Cl. G06F 3/041; B32B 7/12; G09G 3/00

(52) U.S. Cl. 345/173; 345/30; 428/343

(57) ABSTRACT

The invention provides a transparent adhesive sheet for flat panel display, which shows superior level difference absorbability and does not develop bubbles in the adhesion surface to a plastic plate. The transparent adhesive sheet for flat panel display is made of a cured product of a composition comprising (A) a polyoxyalkylene based polymer having at least one alkenyl group in one molecule, (B) a compound having an average of not less than 2 and less than 5 hydrosilyl groups in one molecule, and (C) a hydrosilylation catalyst, wherein the transparent adhesive sheet has a shear storage elastic modulus (G′) of not more than 1.0×10⁵ Pa at 25° C. and 1 Hz, and a gel fraction of not less than 40%.

### TECHNICAL FIELD

The present invention relates to a transparent adhesive sheet for flat panel display, and particularly to a transparent adhesive sheet for flat panel display, which shows superior level difference absorbability and can adhere to a plastic plate without foaming.

### BACKGROUND ART

Conventionally, in a flat panel display such as a liquid crystal display and the like, the display panel and a protective panel containing a transparent plate such as acrylic plate, glass plate and the like, which protects the display panel, are set with a given gap so that, when an impact of some kind is applied to the flat panel display, the impact will not be transmitted to the display panel.

However, since the gap is generally a layer of air, light reflection loss is high due to the difference in the refractive index between the layer of air and the material constituting the above-mentioned display panel and protective panel, thus problematically failing to afford good visibility.

Thus, for example, in a liquid crystal display, to remove the gap (air layer) between a liquid crystal panel and a protection panel, a technique for integrating a liquid crystal panel and a transparent plate by close adhesion is known, which includes adhering a transparent plate for protection to a liquid crystal panel via a transparent adhesive sheet comprising acrylic adhesive (e.g., sheet obtained by processing acrylic acid ester copolymer crosslinked by epoxy, isocyanate, melamine or metal compound crosslinking agent, UV curing acrylic adhesive and the like) (patent reference 1 etc.).

### DOCUMENT LIST

### Patent Document

patent document 1: JP-A-2002-348546

### SUMMARY OF THE INVENTION

### Problems to be Solved by the Invention

For mobile phones, portable game devices and the like, light-weightedness is important for equipment portability, handling property during operation and the like. As a protective transparent plate for liquid crystal displays, therefore, transparent plastic plates such as acrylic plate, polycarbonate plate and the like are increasingly used as compared to glass plates. On the other hand, compact liquid crystal displays mounted on mobile phones, portable game devices and the like generally have a black printed layer formed on the end portion of the outer periphery of the protective transparent plate to facilitate visualization of the liquid crystal display. As a result, the surface of the transparent plate has a difference in the level due to the thickness of the printed layer. When a protective transparent plate having a black printed layer is adhered to a display panel via a transparent adhesive sheet, and the transparent adhesive sheet cannot absorb the difference, the transparent adhesive sheet develops delamination (bubble and air gap) around the end portion of the printed layer. The delamination causes loss in light reflectance to possibly degrade the visibility of the liquid crystal display.

To achieve superior level difference absorbability, therefore, a soft transparent adhesive sheet is preferable, and the present inventors have set the shear storage elastic modulus (G′) of the adhesive sheet to a low level in an attempt to soften an acrylic transparent adhesive sheet. While the acrylic transparent adhesive sheet having a low shear storage elastic modulus (G′) showed superior level difference absorbability, it also posed problems in that foaming occurred in the adhesion surface to the protective transparent plate (transparent plastic plate), and the visibility decreased due to the developed bubbles.

The present invention has been made in view of the above-mentioned situation, and the problem to be solved by the invention is provision of a transparent adhesive sheet for flat panel display, which shows superior level difference absorbability and does not develop bubbles in the adhesion surface to a plastic plate.

### Means of Solving the Problems

The present inventors have conducted intensive studies in an attempt to solve the aforementioned problems and found that a polyoxyalkylene adhesive sheet obtained from a cured product of a composition containing a polyoxyalkylene polymer having at least one alkenyl group in one molecule (Component A), a compound having two or more hydrosilyl groups on average in one molecule (Component B) and a hydrosilylation catalyst (Component C) can be adhered to a plastic plate without developing bubbles even when the shear storage elastic modulus (G′) is comparatively low, which resulted in the completion of the present invention.

Accordingly, the present invention provides the following.

(1) A transparent adhesive sheet for flat panel display comprised of a cured product of a composition comprising the following components A-C, which shows a shear storage elastic modulus (G′) of not more than 1.0×10⁵ Pa at 25° C. and 1 Hz, and a gel fraction of not less than 40%:

A: a polyoxyalkylene based polymer having at least one alkenyl group in one molecule

B: a compound having an average of not less than 2 and less than 5 hydrosilyl groups in one molecule, and

C: a hydrosilylation catalyst.

(2) The transparent adhesive sheet of the above-mentioned (1), for use in between two adjacent layers, at least one being a plastic plate or a plastic film, in a front multi-layer structure of the flat panel display.
(3) The transparent adhesive sheet of the above-mentioned (2), wherein the two adjacent layers are a protective transparent plate comprised of a transparent plastic plate or a transparent plastic film and a display panel.
(4) The transparent adhesive sheet of the above-mentioned (1), which shows a shear storage elastic modulus (G′) of not less than 0.1×10⁵ Pa at 25° C. and 1 Hz.
(5) The transparent adhesive sheet of the above-mentioned (1), which shows a gel fraction of not more than 90%.
(6) A flat panel display comprising a protective transparent plate comprised of a transparent plastic plate or transparent plastic film and a display panel, which are integrated by adhesion via the transparent adhesive sheet of the above-mentioned (1) disposed between the protective transparent plate and the display panel.
(7) A flat panel display comprising a protective transparent plate comprised of a transparent plastic plate or transparent plastic film, a display panel and a touch panel inserted between the protective transparent plate and the display panel, wherein the transparent adhesive sheet of the above-mentioned (1) is disposed between a transparent plastic plate on the outermost layer of the touch panel and the protective transparent plate, and between a transparent plastic plate on the outermost layer of the other side of the touch panel and the display panel, whereby the protective transparent plate, the display panel and the touch panel are integrated by adhesion.

### Effect of the Invention

The transparent adhesive sheet of the present invention has superior flexibility, and adheres to a plastic plate without developing bubbles. Therefore, it can adhere, for example, even to a transparent plastic plate having a level difference on the surface thereof due to a black printed layer formed on the end portion of the outer periphery, which is used as a protective transparent plate, without forming an air gap or bubble. Therefore, using the transparent adhesive sheet of the present invention, a flat panel display can be realized, wherein a multi-layer structure part (front multi-layer structure part) comprising at least a protective transparent plate comprised of a transparent plastic plate and a display panel, which part being formed on the front side of the flat panel display (i.e., display surface of flat panel display), is free of an air gap or bubble that degrades visibility, and adjacent layers in the front multi-layer structure part are integrated by adhesion.

### BRIEF DESCRIPTION OF THE DRAWINGS

FIG. 1 is a schematic sectional view of a liquid crystal display wherein a protective transparent plate comprised of a transparent plastic plate is integrated with a liquid crystal panel by adhesion via the transparent adhesive sheet of the present invention.

FIG. 2 is a schematic sectional view of a liquid crystal display wherein a touch panel and a protective transparent plate comprised of a transparent plastic plate are integrated with a liquid crystal panel by adhesion via the transparent adhesive sheet of the present invention.

### DESCRIPTION OF EMBODIMENTS

The present invention is explained in the following by referring to a preferable embodiment.

The “flat panel display” in the present invention is a concept including a liquid crystal display (LCD), a plasma display panel (PDP), an organic or inorganic electroluminescent display (ELD), a surface electrolysis display (SED) and the like.

In addition, the “display panel” means a panel component containing a display material in, for example, various flat-panel displays such as a panel component containing a liquid crystal material in a liquid crystal display (LCD) (hereinafter also to be referred to as a “liquid crystal panel”) and the like, and a “display module” is the panel member mounted with a driver IC and the like for driving.

The transparent adhesive sheet of the present invention is a polyoxyalkylene adhesive sheet comprising a cured product of a composition comprising the following Components A-C, which characteristically shows a shear storage elastic modulus (G′) of not more than 1.0×10⁵ Pa at 25° C. and 1 Hz, and a gel fraction of not less than 40%:

A: a polyoxyalkylene based polymer having at least one alkenyl group in one molecule

B: a compound comprising an average of not less than 2 and less than five hydrosilyl groups in one molecule and

C: a hydrosilylation catalyst.

The transparent adhesive sheet of the present invention has superior flexibility and high adhesion force (release force) to a plastic plate or a plastic film without developing bubbles. In addition, it also adheres to a surface of various materials other than plastic such as glass and the like with high adhesion force (release force) without developing bubbles. Therefore, the transparent adhesive sheet of the present invention can integrate two adjacent layers, at least one being a plastic plate or a plastic film, in a front multi-layer structure part comprising at least a display panel and a protective transparent plate or a protective transparent plate in various flat panel displays such as liquid crystal display (LCD), Plasma Display (PDP), organic or inorganic electroluminescence display (ELD), surface-conduction electron-emitter display (SED) and the like, by adhesion without developing bubbles therebetween by being disposed between the two layers. In addition, since the adhesive sheet has extremely high flexibility as shown by a shear storage elastic modulus (G′) at 25° C. and 1 Hz of not more than 1.0×10⁵ Pa, it can be closely adhered, without allowing an air gap, to a surface having a level difference such as the surface of a protective transparent plate with a black printed layer (generally about thickness 1-50 μm) formed on the end portion along the outer periphery thereof. Therefore, by being disposed between two adjacent layers, at least one having a level difference on the surface, in a front multi-layer structure part, the adhesive sheet can integrate the two layers without producing an air gap therebetween.

In the above, the “plastic plate” and “plastic film” are indicated alongside, and the “protective transparent plate” and the “protective transparent film” are indicated alongside. The “plate” and “film” suggest that a sheet having a comparatively larger thickness such as glass and plastic is generally referred to as a “plate” and a sheet having a comparatively smaller thickness is generally referred to as a “film”, and they are indicated alongside to encompass glass and plastic sheets as a whole in the field of flat panel display. In the following explanation, therefore, the “plastic plate” is used to describe a concept including a “plastic film”, and the “protective transparent plate” is used to describe a concept including a “protective transparent film”.

The above-mentioned “front multi-layer structure part” means a multi-layer structure (laminate structure) part containing at least a display panel and a protective transparent plate on the front side of a flat panel display (i.e., visual surface of flat panel display). The part contains at least a display panel and a protective transparent plate, and sometimes further contains, between the display panel and the protective transparent plate, one or more functional layers other than the protective transparent plate.

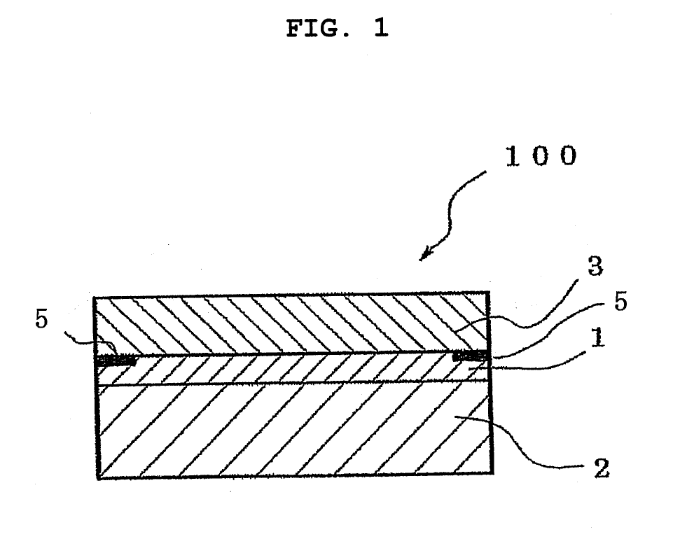

FIG. 1 is a schematic sectional view of a liquid crystal display wherein a protective transparent plate comprised of a transparent plastic plate is integrated with a liquid crystal display panel by adhesion via the transparent adhesive sheet of the present invention. In the liquid crystal display 100, a transparent adhesive sheet 1 of the present invention is placed between a liquid crystal display panel 2 and a protective transparent plate 3 comprised of a transparent plastic plate, the transparent adhesive sheet 1 is adhered to the liquid crystal display panel 2 and the protective transparent plate 3 comprised of a transparent plastic plate, whereby the liquid crystal panel 2 and the protective transparent plate 3 are integrated by adhesion. In the Figure, symbol 5 is, for example, a black printed layer formed on the outer periphery of the protective transparent plate 3, and the transparent adhesive sheet 1 absorbs a level difference due to the black printed layer 5 and adheres to the protective transparent plate 3 without clearance. As the transparent plastic plate to be used for the protective transparent plate 3, plastic plates comprised of (meta)acrylic resin (e.g., PMMA), polycarbonate (PC), polypropylene (PP), polyphenylene sulfide, poly(ethylene terephthalate) (PET), poly(ethylene naphthalate) (PEN), triacetylcellulose (TAC) resin, ARTON® resin, epoxy resin, polyimide resin, polyetherimide resin, polyamide resin, polysulfone, polyethersulfone and the like are used. Transparent adhesive sheet 1 of the present invention can adhere to the surface of these various transparent plastic plates without developing bubbles.

The display panel in a liquid crystal display is generally a panel component having at least a laminate structure wherein a deflecting plate (polarization filter)/a transparent plate (glass plate, plastic plate)/a liquid crystal material sandwiched between transparent electrodes/a transparent plate (glass plate, plastic plate)/a deflecting plate (polarization filter) are laminated in this order. The transparent adhesive sheet of the present invention also adheres, with high adhesion force, to a polarizing plate (polarizing filter) provided on the outermost layer of such panel component. Specifically, a deflecting plate (polarization filter) is generally constituted by sandwiching a polyvinyl alcohol film (PVA) stained with iodine with two pieces of triacetylcellulose (TAC), wherein the surface of TAC is not treated, or hard coat treated, anti-glare treated, anti-reflection treated, antistatic treated and the like. The transparent adhesive sheet 1 of the present invention also shows high adhesiveness to these materials. In the liquid crystal display of the above-mentioned one example (FIG. 1), the transparent adhesive sheet 1 of the present invention is placed between the protective transparent plate 3 comprised of a transparent plastic plate and a polarizing plate (polarizing filter), and integrates them by close adhesion.

In flat-panel displays represented by liquid crystal displays, an impact mitigation film (e.g., poly(ethylene terephthalate) (PET) film, poly(ethylene naphthalate) (PEN) film, polycarbonate (PC) film, polypropylene (PP) film, polyethylene (PE) film etc.) which mitigates impact when a protective transparent plate is subjected to impact from the outside, or a shatterproof film (e.g., poly(ethylene terephthalate) (PET) film, poly(ethylene naphthalate) (PEN) film, polycarbonate (PC) film, polypropylene (PP) film, polyethylene (PE) film etc.) for preventing a protective transparent plate from shattering when it is broken may be inserted between a telltale module (telltale panel) and a protective transparent plate. To improve view angle and contrast ratio of display screens, an optical compensation film (e.g., polycarbonate (PC) film, cycloolefin resin film, acrylic resin film, the above-mentioned transparent films and those other than the above-mentioned transparent films, to which a liquid crystal material is applied and oriented on the surface, etc.) or a glass plate (film) may be inserted. Furthermore, an attached mechanism such as a touch panel to (panel component consisting of a glass plate having a transparent electrode (detection electrode layer)/an adhesive layer/a glass plate having a transparent electrode (driving electrode layer)) and the like may be inserted between a display panel and a protective transparent plate. Thus, when a front multi-layer structure part wherein one or more function layers other than the protective transparent plate are provided between the display panel and the protective transparent plate is formed, the transparent adhesive sheet of the present invention can be used for adhesion of two adjacent layers in the front multi-layer structure part, since it shows superior adhesiveness to various materials.

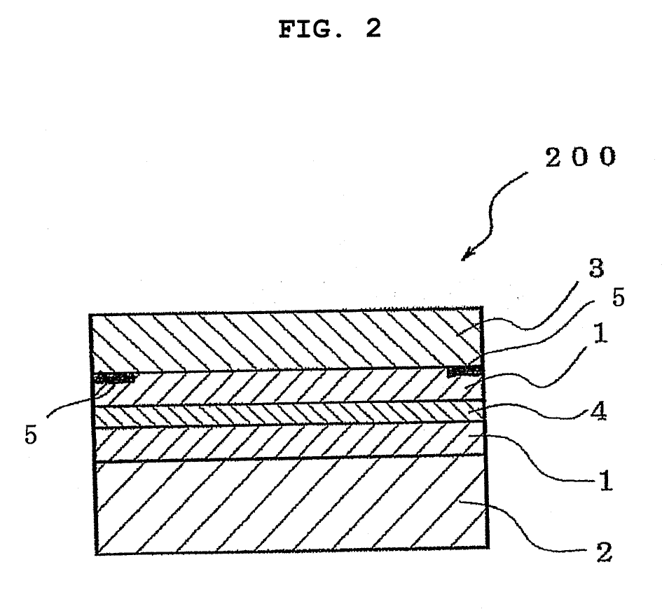

FIG. 2 is a schematic sectional view of a liquid crystal display wherein the transparent adhesive sheet of the present invention is used to adhere layers in the front multi-layer structure part. In the liquid crystal display 200, a touch panel [laminate of a transparent plastic plate having a transparent electrode (detection electrode layer)/an adhesion layer/a transparent plastic plate having a transparent electrode (driving electrode layer)]4 is provided between a liquid crystal display panel 2 and a protective transparent plate 3 comprised of a transparent plastic plate. The transparent adhesive sheet 1 of the present invention is inserted between the liquid crystal display panel 2 and the touch panel 4, and between the touch panel 4 and the protective transparent plate 3, whereby the touch panel 4 and the protective transparent plate 3 are integrated with the liquid crystal display panel 2 by close adhesion. The transparent adhesive sheet 1 of the present invention can also be used for an adhesion layer to adhere a transparent plastic plate having two sheets of transparent electrodes in the touch panel 4. In the Figure, symbol 5 is a black printed layer formed on the end portion of the outer periphery of the protective transparent plate (transparent plastic plate) 3.

As shown, a touch panel is inserted between a display panel and a protective transparent plate comprised of a transparent plastic plate, and the transparent adhesive sheet of the present invention is, placed between the transparent plastic plate on the outermost layer of the touch panel and the protective transparent plate, and between the transparent plastic plate on the outermost layer of the touch panel and the display panel. Then, the transparent adhesive sheet also adheres with high adhesion force to the transparent plastic plate constituting the outermost layer of the touch panel without developing bubbles. Therefore, a flat panel display with a touch panel, which is free of inconveniences such as decreased visibility of displayed images and the like, and has superior mechanical durability, can be realized.

In the transparent adhesive sheet of the present invention, the “polyoxyalkylene polymer having at least one alkenyl group in one molecule” of Component A is not subject to limitation, and various types can be used. In particular, one wherein the main chain of the polymer has a repeat unit represented by the formula (1) shown below is suitable.

—R¹—O— Formula (1):

wherein R¹ is an alkylene group.

R¹ is preferably a linear or branched alkylene group having 1 to 14, more preferably 2 to 4, carbon atoms.

As specific examples of the repeating unit represented by the formula (1), —CH₂O—, —CH₂CH₂O—, —CH₂CH(CH₃)O—, —CH₂CH(C₂H₅)O—, —CH₂C(CH₃)₂O—, —CH₂CH₂CH₂CH₂O— and the like can be mentioned. The main chain skeleton of the polyoxyalkylene based polymer may consist of only one kind of repeating unit, and may consist of two kinds or more of repeating units. Particularly, with regard to availability and workability, a polymer with —CH₂CH(CH₃)O— as the main repeating unit is preferable. In the main chain of the polymer, a repeating unit other than the oxyalkylene group may be contained. In this case, the total sum of oxyalkylene units in the polymer is preferably not less than 80% by weight, particularly preferably not less than 90% by weight.

Although the polymer may be a linear polymer or a branched polymer, or a mixture thereof, it is preferable, for obtaining good adhesiveness, that the component A polymer contain a linear polymer at not less than 50% by weight.

The molecular weight of the component A polymer is preferably 500 to 50,000, more preferably 5,000 to 30,000, in terms of number-average molecular weight. If the number-average molecular weight is less than 500, the curing product obtained tends to be too brittle; conversely, if the number-average molecular weight exceeds 50,000, the curing product obtained tends to be so viscous that the workability is considerably reduced; therefore, these cases are undesirable. As mentioned herein, number-average molecular weight refers to a value obtained by the gel permeation chromatography (GPC) method.

The component A polymer preferably has a narrow molecular weight distribution wherein the ratio of weight-average molecular weight and number-average molecular weight (Mw/Mn) is not more than 1.6; a polymer having an Mw/Mn of not more than 1.6 produces a decreased viscosity of the composition and offers improved workability. Hence, the Mw/Mn is more preferably not more than 1.5, still more preferably not more than 1.4. As mentioned herein, Mw/Mn refers to a value obtained by the gel permeation chromatography (GPC) method.

Here, measurements of molecular weight by the GPC method were performed using a GPC apparatus manufactured by Tosoh Corporation (HLC-8120GPC), and weight-average molecular weights were calculated on a polystyrene basis. The measuring conditions are as follows:

Sample concentration: 0.2% by weight (THF solution)

Sample injection volume: 10 μl

Eluent: THF

Flow rate: 0.6 ml/min

Measuring temperature: 40° C.

Column: sample column TSKgel GMH-H(S)

Detector: differential refractometer

With regard to the component A polymer (polyoxyalkylene polymer having at least one alkenyl group in one molecule), the alkenyl group is not subject to limitation, but an alkenyl group represented by the formula (2) shown below is suitable.

H₂C═C(R²)— General formula (2):

(wherein R² is a hydrogen atom or a methyl group)

The mode of binding of the alkenyl group to the polyoxyalkylene polymer is not subject to limitation; for example, alkenyl group direct bond, ether bond, ester bond, carbonate bond, urethane bond, urea bond and the like can be mentioned.

As specific examples of the component A polymer, a polymer represented by the formula (3): {H₂C═C(R^{3a})—R^{4a}—O}a₁R^{5a} (wherein R^{3a} is a hydrogen atom or a methyl group; R^{4a} is a divalent hydrocarbon group having 1 to 20 carbon atoms, optionally having one or more ether groups, R^{5a} is a polyoxyalkylene polymer residue; a₁ is a positive integer.) can be mentioned. As R^{4a} in the formula, specifically, —CH₂—, —CH₂CH₂—, —CH₂CH₂CH₂—, —CH₂CH(CH₃)CH₂, —CH₂CH₂CH₂CH₂—, —CH₂CH₂OCH₂CH₂—, or —CH₂CH₂OCH₂CH₂CH₂— and the like can be mentioned; for the ease of synthesis, —CH₂— is preferable.

A polymer having an ester bond, represented by the formula (4): {H₂C═C(R^{3b})—R^{4b}—OCO}a₂R^{5b}

(wherein R^{3b}, R^{4b}, R^{5b} and a₂ have the same definitions as those of R^{3a}, R^{4a}, R^{5a}, and a₁, respectively)
can also be mentioned.

A polymer represented by the formula (5): {H₂C═C(R^{3b})}a₃R^{5c} (wherein R^{3c}, R^{5c} and a₃ have the same definitions as those of R^{3a}, R^{5a}, and a₁, respectively)

can also be mentioned.

Furthermore, a polymer having a carbonate bond, represented by the formula (6): {H₂C═C(R^{3d})—R^{4d}—O(CO)O}a₄R^{5d} (wherein, R^{3d}, R^{4d}, R^{5d} and a₄ have the same definitions as those of R^{3a}, R^{4a}, R^{5a} and a₁, respectively)

can also be mentioned.

It is preferable that at least 1, preferably 1 to 5, more preferably 1.5 to 3, alkenyl groups be present in one molecule of the component A polymer. If the number of alkenyl groups contained in one molecule of the component A polymer is less than 1, the curing is insufficient; if the number exceeds 5, the mesh structure becomes so dense that the polymer sometimes fails to exhibit a good adherence. The component A polymer can be synthesized according to the method described in JP-A-2003-292926, and any commercially available product can be used as is.

The “compound containing average two or more and less than 5 hydrosilyl groups in one molecule” of Component B is not particularly limited and may be any as long as it is a compound containing average two or more and less than 5 hydrosilyl groups (group having Si—H bond) in one molecule. From the viewpoint of easy availability of the starting materials and compatibility with Component A, organohydrogenpolysiloxane denatured by an organic component is particularly preferable. Specific examples of the structure of polyorganohydrogensiloxane denatured by such organic component include those shown by

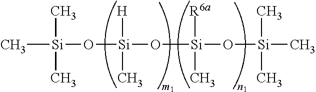

(wherein 2≦m₁+n₁≦50, 2≦m₁<5, and 0≦n₁. R^{6a} is a hydrocarbon group having 2 to 20 carbon atoms in the main chain thereof, optionally comprising one or more phenyl groups),

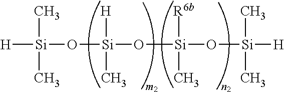

(wherein 0≦m₂+n₂≦50, 0≦m₂<3, and 0≦n₂. R^{6b} is a hydrocarbon group having 2 to 20 carbon atoms in the main chain thereof, optionally comprising one or more phenyl groups),
or,

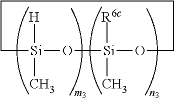

(wherein 3≦m₃+n₃≦20, 2≦m₃<5, and 0≦n₃<18. R^{6c} is a hydrocarbon group having 2 to 20 carbon atoms in the main chain thereof, optionally having one or more phenyl groups) and the like, and ones having two or more of these units, represented by the following:

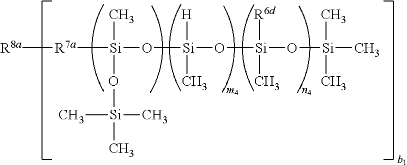

(wherein 1≦m₄+n₄≦50, 1≦m₄, and 0≦n₄. R^{6d} is a hydrocarbon group having 2 to 20 carbon atoms in the main chain thereof, optionally having one or more phenyl groups. 2≦b₁, m₄×b₁<5. R^{8a} is a divalent to tetravalent organic group, and R^{7a} is a divalent organic group, but R^{7a} may be absent depending on the structure of R^{8a}),

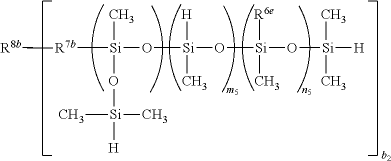

(wherein 0≦m₅+n₅≦50, 0≦m₅, and 0≦n₅. R^{6e} is a hydrocarbon group having 2 to 20 carbon atoms in the main chain thereof, optionally having one or more phenyl groups. 2≦b₂, b₂×m₅<3. R^{8b} is a divalent to tetravalent organic group, and R^{7b} is a divalent organic group. However, R^{7b} may be absent depending on the structure of R^{8b}.), or

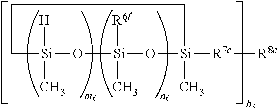

(wherein 3≦m₆+n₆≦50, 1≦m₆, and 0≦n₆. R^{6f} is a hydrocarbon group having 2 to 20 carbon atoms in the main chain thereof, optionally comprising one or more phenyl groups. 2≦b₃, m₆×b₃<5. R^{8c} is a divalent to tetravalent organic group, and R^{7c} is a divalent organic group. However, R^{7c} may be absent depending on the structure of R^{8c}.) and the like.

The component B preferably has good compatibility with the component A and the component C, or good dispersion stability in the system. Particularly, if the viscosity of the entire system is low, use of an ingredient whose compatibility with any of the above-described ingredients is low as the component B sometimes causes phase separation and a curing failure.

As a specific example of the component B having relatively good compatibility with the component A and the component C, or relatively good dispersion stability, the following can be mentioned.

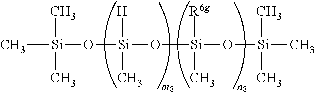

(wherein 2≦m₈<5 and 0≦n₈≦5, R^{6g} is a hydrocarbon group having eight or more carbon atoms.)

As specific preferable examples of the component B, polymethylhydrogen siloxane can be mentioned; for assuring compatibility with the component A and adjusting the SiH content, a compound modified with α-olefin, styrene, α-methylstyrene, allylalkyl ether, allylalkyl ester, allylphenyl ether, allylphenyl ester or the like can be mentioned; as an example, the following structure can be mentioned.

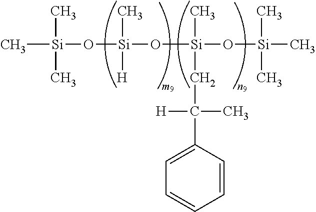

(wherein 2≦m₉<5 and 1≦n₉≦20.)

The component B can be synthesized by a commonly known method, and any commercially available product can be used as is.

In the present invention, the component C hydrosilylation catalyst is not subject to limitation; an optionally chosen one can be used. As specific examples, chloroplatinic acid; simple substance platinum; solid platinum carried by a carrier such as alumina, silica, or carbon black; a platinum-vinylsiloxane complex {for example, Ptₙ(ViMe₂SiOSiMe₂Vi)ₘ, Pt[(MeViSiO)₄]ₘ and the like}; a platinum-phosphine complex {for example, Pt(PPh₃)₄, Pt(PBu₃)₄ and the like}; a platinum-phosphite complex {for example, Pt[P(OPh)₃]₄, Pt[P(OBu)₃]₄ and the like}; Pt(acac)₂; the platinum-hydrocarbon conjugates described in U.S. Pat. Nos. 3,159,601 and 3,159,662 of Ashby et al.; the platinum alcoholate catalyst described in U.S. Pat. No. 3,220,972 of Lamoreaux et al. and the like can be mentioned. (In the formulas above, Me represents a methyl group, Bu represents a butyl group, Vi represents a vinyl group, Ph represents a phenyl group, acac represents an acetylacetonate, and each of n and m represents an integer.)

As examples of catalysts other than platinum compounds, RhCl(PPh₃)₃, RhCl₃, Rh/Al₂O₃, RuCl₃, IrCl₃, FeCl₃, AlCl₃, PdCl₂.2H₂O, NiCl₂, TiCl₄ and the like can be mentioned.

These catalysts may be used alone, and may be used in combination of 2 or more kinds. With regard to catalyst activity, chloroplatinic acid, a platinum-phosphine complex, a platinum-vinylsiloxane complex, Pt(acac)₂ and the like are preferable.

Although the amount of the component C formulated is not subject to limitation, from the viewpoint of assurance of composition potlife and sheet transparency, the amount is generally not more than 1×10⁻¹ mol, preferably not more than 5.3×10⁻² mol, relative to 1 mol of alkenyl groups in the component A; particularly, from the viewpoint of sheet transparency, the amount is more preferably not more than 3.5×10⁻² mol, particularly preferably not more than 1.4×10⁻³ mol. If the amount exceeds 1×10⁻¹ mol relative to 1 mol of alkenyl groups in the component A, the finished impact absorption sheet is likely to undergo yellowing and the transparency of the sheet tends to be damaged. If the amount of the component C formulated is too low, the composition curing speed is slow, and the curing quality tends to be unstable; therefore, the amount is preferably not less than 8.9×10⁻⁵ mol, more preferably not less than 1.8×10⁻⁴ mol, per 1 mol of alkenyl group in component A.

As mentioned above, it is important that the transparent adhesive sheet of the present invention show a shear storage elastic modulus (G′) of not more than 1.0×10⁵ Pa at 25° C. and 1 Hz and a gel fraction of not less than 40%. Since the shear storage elastic modulus (G′) is not more than 1.0×10⁵ Pa at 25° C. and 1 Hz, the transparent adhesive sheet shows superior level difference absorbability. The shear storage elastic modulus (G′) is preferably not more than 0.6×10⁵ Pa. However, when the shear storage elastic modulus (G′) is too small, the transparent adhesive sheet cannot maintain the shape as a sheet, which markedly impairs the workability. Thus, the lower limit thereof is preferably not less than 0.1×10⁵ Pa, more preferably not less than 0.2×10⁵ Pa.

In addition, since the gel fraction of the transparent adhesive sheet is not less than 40%, it can be strongly adhered to a plastic surface and surfaces of various materials without developing bubbles. The gel fraction is preferably not less than 45%. When the gel fraction is too large, the flexibility of the transparent adhesive sheet is markedly impaired to show degraded level difference absorbability in the black printed layer (layer marked with symbol 5 in FIGS. 1 and 2). Thus, the upper limit is preferably not more than 90%, more preferably not more than 70%.

The shear storage elastic modulus (G′) of the transparent adhesive sheet of the present invention is particularly related to the numbers of hydrosilyl groups in one molecule of Component B. For the shear storage elastic modulus (G′) of the transparent adhesive sheet at 25° C. and 1 Hz to be not more than 1.0×10⁵ Pa, it is essential that the average number of the hydrosilyl groups in one molecule of Component B be less than 5.

In addition, the gel fraction of the transparent adhesive sheet of the present invention is particularly related to the quantitative ratio of component A and component B in the composition containing components A-C. To provide a transparent adhesive sheet having a gel fraction of not less than 40%, it is important that the quantitative ratio of component A and component B be controlled such that the functional group ratio (molar ratio) of the amount of hydrosilyl group in component B (total number of moles of hydrosilyl group) to the amount of alkenyl group in component A (total number of moles of alkenyl group) is not less than 0.50. When the gel fraction is too high, the transparent adhesive sheet becomes rigid. Therefore, the upper limit of the functional group ratio (molar ratio) is preferably not more than 1.0.

Such composition containing the components A to C may contain a storage stability improving agent for the purpose of improving the storage stability. As this storage stability improving agent, a commonly known compound known as a storage stabilizer for the component B of the present invention can be used without limitation. For example, a compound comprising an aliphatic unsaturated bond, an organic phosphorus compound, an organic sulfur compound, a nitrogen-containing compound, a tin compound, an organic peroxide and the like can be suitably used. Specifically, 2-benzothiazolyl sulfide, benzothiazole, thiazole, diethylacetylene dicarboxylate, diethylacetylene dicarboxylate, 2,6-di-t-butyl-4-methylphenol, butylhydroxyanisole, vitamin E, 2-(4-morpholinyldithio)benzothiazole, 3-methyl-1-butene-3-ol, 2-methyl-3-butene-2-ol, organosiloxane containing an acetylenic unsaturated group, acetylene alcohol, 3-methyl-1-butyl-3-ol, diallyl fumarate, diallyl maleate, diethyl fumarate, diethyl maleate, dimethyl maleate, 2-pentenenitrile, 2,3-dichloropropene and the like can be mentioned, but these are not to be construed as limitative.

Where necessary, moreover, an adhesion-imparting agent may be added to improve adhesiveness. As examples of the adhesion provider, various silane coupling agents, epoxy resins and the like can be mentioned. In combination with a silane coupling agent and an epoxy resin, a catalyst for reacting silyl groups or epoxy groups can be added. When using them, their influence on the hydrosilylation reaction must be taken into consideration. Various filling agents, antioxidants, ultraviolet absorbents, pigments, surfactants, solvents, and silicon compounds may be added to the composition as appropriate. As specific examples of the above-described filling agents, silica micropowder, calcium carbonate, clay, talc, titanium oxide, zinc oxide, diatomaceous earth, barium sulfate and the like can be mentioned. Of these filling agents, silica micropowder, particularly micropowder silica having a particle diameter of about 50 to 70 nm (the BET specific surface area is 50 to 380 m²/g) is preferable; in particular, surface-treated hydrophobic silica is particularly preferable because of its high function to improve the strength in the preferred direction. Furthermore, a tackifier resin may be added to the composition as required to enhance the tack and other characteristics thereof; as examples of the tackifier resin, terpene resin, terpene phenol resin, petroleum resin, rosin ester and the like can be mentioned, one of which can be freely selected according to the intended use.

For the characteristic improvements, resins such as phenol resin, acrylic resin, styrene resin, and xylene resin can be added. An adhesive ingredient such as an acrylic adhesive, a styrene block adhesive, or an olefin adhesive can be added for the same purpose.

The transparent adhesive sheet of the present invention shows high adhesion force (release force) to various materials. For example, the release force from an acrylic sheet (PMMA plate) is not less than 3.5N/25 mm, the release force from a polycarbonate (PC) plate is not less than is 3.5N/25 mm, the release force from a poly(ethylene terephthalate) (PET) film is not less than 4.5N/25 mm, and the release force from a glass plate is not less than 1.0N/25 mm.

The release force here is a value obtained by preparing a 25 mm×150 mm sample piece by adhering a support (release liner) is made of a 25 μm-thick PET film to one surface of an adhesive sheet having a 200 μm-thick adhesive layer, adhering the sample piece to an adherend (PMMA plate, polycarbonate plate, poly(ethylene terephthalate)film, glass plate) with 2 kg pressure, standing still the adhered sample piece at 23° C. for 24 hr, detaching the piece in a direction at 90° with the adhesion surface at 300 mm/min and measuring the force for release.

The transparent adhesive sheet of the present invention is produced, for example, by the following method.

A composition containing a polyoxyalkylene polymer as a main component (composition at least containing the above-mentioned components A-C) is charged in a stirrer equipped with a vacuum function together with an organic solvent as necessary. The mixture is defoamed by stirring under reduced pressure (in vacuo). The fluid product after said vacuum defoaming is applied (cast) to various supports, and treated with heat to form a sheet. The composition is heat-cured by a heat treatment to give a sheet of the cured product. Coating on the support can be performed using, for example, a commonly known coating apparatus such as a gravure coater; a roll coater such as a kiss coater or a comma coater; a die coater such as a slot coater or a fountain coater; a squeeze coater, a curtain coater and the like. Preferable heat treatment conditions during the coating are 50-200° C. (preferably 100-160° C.) for about 0.01-24 hr (preferably 0.05-4 hr). As the above-described stirrer with vacuum function, a commonly known stirrer equipped with vacuum apparatus may be used; specifically, a planetary (revolution type/rotation type) stirring defoaming apparatus, a defoaming apparatus equipped with a disperser, and the like can be mentioned. The degree of pressure reduction in performing vacuum defoaming is preferably not more than 10 kPa, more preferably not more than 3 kPa. Stirring time varies also depending on the choice of is stirrer and the throughput of fluidized product, and is generally preferably about 0.5 to 2 hours. By the defoaming treatment, bubbles (voids) substantially do not exist in the sheet, and the sheet shows superior optical property (transparency). For example, the Haze value of a sheet measured by the below-mentioned test method is preferably not more than 1.2%, more preferably not more than 0.9%.

Particularly, when the transparent adhesive sheet of the present invention is used to adhere two adjacent layers in a front multi-layer structure part to be mounted on compact equipments such as mobile phones, mobile game machines, car navigation systems and the like, the sheet needs to be processed into a sheet with a small area size. However, for mass production (production efficiency), for example, it is preferable to produce a roll consisting of a laminate structure of a first support (base separator)/cured product layer of composition containing the above-mentioned components A to C (transparent adhesive sheet)/second support (cover separator), and produce sheets by a punching process while developing the roll.

The above-mentioned roll can be prepared by, for example, a mold release treatment by applying a mold release treatment agent to a first support, stirring and vacuum defoaming the composition containing the above-mentioned components A to C, applying (casting) the fluidized product after vacuum defoaming to a first support, heat treating the supported to give a sheet, adhering a second support after a mold release treatment to the sheet, and winding the sheet into a roll.

Specific examples of the first and second supports include films (sheets) having a single layer made of thermoplastic resin such as polyester (e.g., polybutylene terephthalate (PBT) etc.), ionomer resin wherein ethylene-methacrylic acid copolymer are intermolecularly crosslinked with metal ion (Na⁺, Zn²⁺ etc.), EVA (ethylene-vinyl acetate copolymer), PVC (polyvinyl chloride), EEA (ethylene-ethyl acrylate copolymer), PE (polyethylene), PP (polypropylene), polyamide, polybutyral, polystyrene and the like; various thermoplastic elastomers showing rubber elasticity such as polystyrene, polyolefin, polydiene, vinyl chloride, polyurethane, polyester, polyamide, fluororesin, chlorinated polyethylene, polynorbornane, polystyrene-polyolefin copolymer, (hydrogenated) polystyrene-butadiene copolymer, polystyrene-vinylpolyisoprene copolymer and the like; polyolefin such as polyethylene, polypropylene and the like blended with a thermoplastic elastomer and the like, films (sheets) having multiple layers (laminate) made of polyolefin (polypropylene (PP) or polyethylene (PE) etc.)/thermoplastic resin (e.g., EVA)/polyolefin, polyolefin (PP or PE)+thermoplastic elastomer/polyolefin (PP or PE), PP/PE/PP and the like, composite multi-layers (laminate) of polyolefin+thermoplastic elastomer at different blending ratios, etc., and the like. In addition, impregnated paper, coated paper, quality paper, craft paper, cloth, acetate cloth, non-woven fabric, glass cloth and the like can be mentioned.

Examples of the agent for mold release treatment to be used for the first and, second supports include silicone mold release treating agent, fluorine mold release treating agent, long chain alkyl mold release treating agent and the like. Of these, a silicone mold release treating agent is preferable. As the curing method, a curing method such as UV irradiation, electron beam irradiation and the like are preferably used. Furthermore, of the silicone mold release treating agents, a cationic polymerizable UV curing silicone mold release treating agent is preferable. A cationic polymerizable UV curing silicone mold release treating agent is a mixture of a cationic polymerizable silicone (polyorganosiloxane having an epoxy functional group in a molecule) and an onium salt photoinitiator. Such agent wherein the onium salt photoinitiator is a boron photoinitiator is particularly preferable. Using such a cationic polymerizable UV curing silicone mold release treating agent wherein the onium salt photoinitiator is a boron photoinitiator, particularly good release property (mold releasability) can be obtained. A cationic polymerizable silicone (polyorganosiloxane having an epoxy functional group in a molecule) has at least two epoxy functional groups in one molecule, which may be linear or branched chain, or a mixture of these. While the kind of an epoxy functional group contained in polyorganosiloxane is not particularly limited, it only needs to permit progress of cationic ring-opening polymerization by an onium salt photoinitiator. Specific examples thereof include γ-glycidyloxypropyl group, β-(3,4-epoxycyclohexyl)ethyl group, β-(4-methyl-3,4-epoxycyclohexyl)propyl group and the like. Such cationic polymerizable silicone (polyorganosiloxane having an epoxy functional group in a molecule) is marketed and a commercially available product can be used. For example, UV9315, UV9430, UV9300, TPR6500, TPR6501 and the like manufactured by Toshiba Silicone Co., Ltd., X-62-7622, X-62-7629, X-62-7655, X-62-7660, X-62-7634A and the like manufactured by Shin-Etsu Chemical Co., Ltd., Poly200, Poly201, RCA200, RCA250, RCA251 and the like manufactured by Arakawa Chemical Industries, Ltd. can be mentioned.

Of the cationic polymerizable silicones, polyorganosiloxane comprising the following structural units (A) to (C) is particularly preferable.

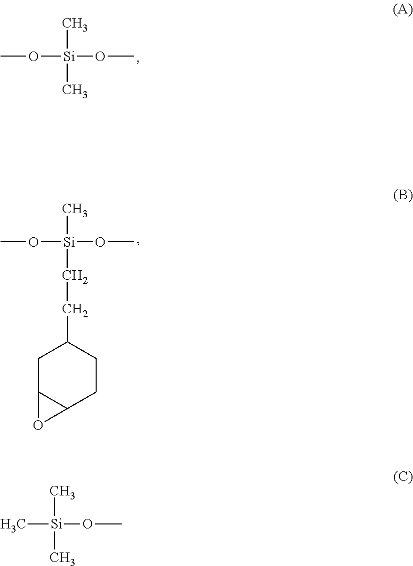

In polyorganosiloxane comprising such structural units (A) to (C), the composition ratio ((A):(B):(C)) of structural units (A) to (C) is particularly preferably 50-95:2-30:1-30 (mol %), and especially preferably 50-90:2-20:2-20 (mol %). Polyorganosiloxane comprising such structural units (A) to (C) is available as Poly200, Poly201, RCA200, X-62-7622, X-62-7629 and X-62-7660.

On the other hand, as the onium salt photoinitiator, a known product can be used without particular limitation. Specific examples include a compound represented by (R¹)₂I⁺X⁻, ArN₂⁺X⁻ or (R¹)₃S⁺X⁻ (wherein R¹ is alkyl group and/or aryl group, Ar is aryl group, X⁻ is [B(C₆H₅)₄]⁻, [B(C₆F₅)₄]⁻, [B(C₆H₄CF₃)₄]⁻, [(C₆F₅)₂BF₂]⁻, [C₆F₅BF₃]⁻, [B(C₆H₃F₂)₄]⁻, BF₄⁻, PF₆⁻, ASF₆⁻, HSO₄⁻, ClO₄⁻ and the like). Of these, a compound of the formula (boron photoinitiator) wherein X⁻ is [B(C₆H₅)₄]⁻, [B(C₆F₅)₄]⁻, [B(C₆H₄CF₃)₄]⁻, [(C₆F₅)₂BF₂]⁻, [C₆F₅BF₃]⁻, [B(C₆H₃F₂)₄]⁻ or BF₄⁻ is preferable, and a compound represented by (R¹)₂I⁺[B(C₆F₅)₄] (wherein R¹ is substituted or unsubstituted phenyl group) (alkyl iodonium, tetrakis(pentafluorophenyl)borate) is particularly preferable. As the onium salt photoinitiator, antimony (Sb) initiator is conventionally known. However, when an antimony (Sb) initiator is used, double detachment occurs and detachment of an impact absorption sheet from a support tends to be difficult.

While the amount of the onium salt photoinitiator to be used is not particularly limited, it is about preferably 0.1-10 parts by weight relative to 100 parts by weight of the cationic polymerizable silicone (polyorganosiloxan). When the amount of use is smaller than 0.1 part by weight, curing of the silicone peel layer may become insufficient. When the amount of use is greater than 10 parts by weight, the cost becomes impractical. When a cationic polymerizable silicone (polyorganosiloxan) and an onium salt photoinitiator are mixed, the onium salt photoinitiator may be dissolved or dispersed in an organic solvent and then mixed with polyorganosiloxan. Specific examples of the organic solvent include alcohol solvents such as isopropyl alcohol, n-butanol and the like; ketone solvents such as acetone, methylethyl ketone and the like; ester solvents such as ethyl acetate and the like, and the like.

A mold release treating agent can be applied, for example, using a general coating apparatus such as those used for roll coater method, reverse coater method, doctor blade method and the like. While the coating amount (solid content) of the mold release treating agent is not particularly limited, it is generally about 0.05-6 mg/cm².

Furthermore, for example, when, in liquid crystal displays (LCD) of mobile game machines, digital video cameras, car navigation systems, compact music players, compact video players, cell phones and the like, what is called a touch panel mechanism permitting operation of equipment by pressing what is displayed on the liquid crystal image screen at the anterior of the liquid crystal panel is to be set, the transparent adhesive sheet of the present invention is adhered to a glass or plastic film with a transparent electrode layer formed thereon. In this case, since the transparent adhesive sheet of the present invention has superior non-corrosiveness of transparent conductive materials (particularly ITO non-corrosiveness), which does not cause corrosion of transparent conductive materials such as ITO, TO (tin oxide), ZnO (zinc oxide), CTO (cadmium tin oxide) and the like, even when the sheet is contacted with the transparent conductive materials, the sheet acts advantageously when a touch panel is present between a protective transparent plate and a display module.

While the thickness of the transparent adhesive sheet of the present invention varies depending on the kind and the like of the flat panel display, it is generally not more than 1000 μm, further not more than 500 μm, to provide a thin flat panel display. A too small a thickness is not preferable for the absorption of a level difference in the printed part formed on the protective panel. Therefore, the lower limit of the thickness is preferably not less than 10 μm, more preferably 15-300 μm, and particularly preferably 25-250 μm.

The transparent adhesive sheet of the present invention can be basically prepared without a solvent, and characteristically contains smaller amounts of low molecular weight, highly volatile oligomer components and monomer components. Therefore, use of the sheet for equipments with a flat panel display, which are increasingly used every day in recent years, is advantageous, since an adverse influence on the human body is small.

### EXAMPLES

The present invention is explained in more detail in the following by referring to Examples and Comparative Examples. The present invention is not limited by the following Examples. The properties of the adhesive sheets of Examples and Comparative Examples were evaluated (tested) by the following methods.

### [Shear Storage Elastic Modulus (G′)]

Adhesive sheets having an adhesive layer thickness of 10-250 μm were adhered to each other to give an about 0.5-1 mm thickness laminate. The laminated sheets were punched out into a φ7.9 mm disc and the obtained disc was used as a measurement sample in the measurements by the following methods.

Measurement apparatus: ARES manufactured by Rheometric Scientific

Measurement condition: measurement temperature 25° C.

Measurement frequency 1 Hz (6.28 rad/sec)

### [Haze Value]

An adhesive sheet having an adhesive layer thickness of 200 μm was cut out to give a test sample piece having the size of 50 mm×25 mm. The sample piece was adhered to a glass substrate (S-1111 (trade name) manufactured by Matsunami GLASS Ind., LTD.) to give a measurement test sample. The haze value was measured using a haze meter (HM-150 (trade name) manufactured by MURAKAMI COLOR RESEARCH LABORATORY CO., Ltd.), where the sample was set to be on an acceptance surface side of the apparatus, a separator (support) of the test piece was peeled off and the measurement was performed according to JIS K 7136.

### [Gel Fraction]

An adhesive sheet having an adhesive layer thickness of 200 μm was cut out to give a test sample piece having the size of 50 mm×50 mm. The sample piece was detached from a separator, placed in a screwtube having a known weight (weight A), and the weight of the screwtube was measured (weight B). The screwtube was filled with ethyl acetate, and stood still for one week (168 hr). Then, the contents were mesh-filtered, and gel was placed in an aluminum petri dish having a known weight (weight C). The aluminum petri dish was placed in a drying machine, heated at 130° C. for 2 hr, taken out, cooled for about 20 min, and the dry weight (weight D) was measured. After the above operation, the gel fraction was calculated from the following formula.

gel fraction=(D−C)×100/(B−A)[%]

### [Level Difference Absorbability]

A PET film (thickness 25 μm) was adhered to a substrateless transparent double-faced adhesive tape (adhesive layer thickness 12 μm) to give a tape with a level difference having a total thickness of 37 μm. The above-mentioned tape with a level difference was adhered to the periphery along four sides of the principal surface of the rectangular glass plate in a frame shape to give a glass plate with a level difference. An adhesive sheet was adhered to the whole surface of the glass plate with a level difference, onto the surface to which the tape with a level difference was adhered, the resulting product was subjected to an autoclave treatment (50° C., 0.5 MPa, 15 min), and the development of delamination of the adhesive layer in the part with a level difference was visually observed.

For evaluation, ◯ (pass) means delamination of adhesive layer was not confirmed in the part with a level difference and x (fail) means delamination was confirmed.

### [Resistance to Foaming]

An adhesive sheet (sample, 50 mm×50 mm) was sandwiched between a polarization plate and a 50 mm×50 mm plastic plate (PMMA plate, PC plate, PET plate), and subjected to an autoclave treatment (50° C., 0.5 MPa, 15 min). After confirmation of the absence of bubbles, the polarization plate/adhesive sheet/plastic plate integration sample was placed under 80° C., 0% rh environment for 150 hr, and the appearance of the sample was visually confirmed after lapse of 150 hr.

For evaluation, ◯ (good) means absence of bubble that can be confirmed by visual observation of the sample from the plastic plate side, Δ (pass) means presence of bubble of not more than 1 mmφ (number of bubbles not more than 2), and x (fail) means presence of bubble exceeding 1 mmφ (number of bubbles not less than 2).

### Example 1

A composition comprising a polyoxyalkylene polymer having 2 alkenyl groups in one molecule (number average molecular weight: about 20000), which is component A, a hydrosilyl compound (average number of hydrosilyl groups in one molecule is 2 or more and less than 5), which is component B, and a hydrosilylation catalyst, which is component C, wherein component A and component B were mixed such that the functional group ratio (molar ratio) of the amount of hydrosilyl group in component B to the amount of alkenyl group in component A was 0.58, and component C was mixed in an amount of 0.9×10⁻³ mol per 1 mol of alkenyl group in component A (manufactured by Kaneka Corporation) was cast in a stirrer with vacuum apparatus (Mini Dappo manufactured by Seatec Corporation), and defoamed by stirring in vacuo (100 Pa) for 1 hr. Then, the vacuum defoamed composition was applied (cast) onto a base separator (support) made of a polyester film (thickness: 100 μm) subjected to a mold release treatment, using a roll coater at room temperature to a composition thickness of 200 μm. The composition was cured by heating in a heating oven at 130° C. for 10 min. A cover separator (release liner) made of a polyester film (thickness: 100 μm) subjected to a mold release treatment in the same manner was adhered to the thus-obtained cured sheet to give a transparent adhesive sheet (measured thickness: 199 μm).

The Haze value of the obtained transparent adhesive sheet was 0.3%, the shear storage elastic modulus (G′) at 25° C. was 0.2×10⁵(Pa), and the gel fraction was 41%. The level difference absorbability and resistance to foaming were evaluated. The results are shown in Table 1.

### Example 2

In the same manner as in Example 1 except that the amount of the hydrosilyl compound, which is component B, in the composition containing components A-C was changed such that the functional group ratio (molar ratio) of the amount of hydrosilyl group to the amount of alkenyl group in component A was 0.68, a transparent adhesive sheet (thickness: 199 μm) was obtained. The Haze value of the obtained transparent adhesive sheet was 0.4%, the shear storage elastic modulus (G′) at 25° C. was 0.6×10⁵(Pa), and the gel fraction was 65%. The level difference absorbability and resistance to foaming of the transparent adhesive sheet were evaluated. The results are shown in Table 1.

### Comparative Example 1

Butyl acrylate (97 parts by weight; hereinafter to be abbreviated as “part”), acrylic acid (3 parts) and azobisisobutyronitrile (0.4 part) were dissolved in ethyl acetate (100 parts), and the mixture was reacted with stirring at about 60° C. to give an acrylic polymer solution. An isocyanate crosslinking agent (3 parts) was added to the obtained solution. The mixture was applied to a 25 μm-thick polyester base separator (support) and dried by heating. A polyester cover separator (release liner) was adhered thereto such that the thickness of the adhesive (applied and dried product) would be 20 μm to give an adhesive sheet having an adhesive thickness of 20 μm. This adhesive sheet having an adhesive thickness of 20 μm was adhered to give an adhesive sheet having an adhesive thickness of 200 μm. The shear storage elastic modulus (G′) of the adhesive sheet at 25° C. was 2.3×10⁵(Pa), and the gel fraction was 64%. The level difference absorbability and resistance to foaming of the transparent adhesive sheet were evaluated. The results are shown in Table 1.

### Comparative Example 2

In a reaction vessel provided with a cooling tube, a nitrogen inlet tube, a thermometer, a UV irradiation and agitator were placed 2-ethylhexy acrylate (manufactured by TOAGOSEI CO., LTD., 100 parts by weight (hereinafter to be abbreviated as “part”)), 2-hydroxyethyl acrylate (ACRICS HEA (trade name) manufactured by TOAGOSEI CO., LTD., 15 parts), a photopolymerization initiator (IRGACURE 184 (trade name) manufactured by Ciba Specialty Chemicals, 0.15 part), and a photopolymerization initiator (IRGACURE 651 (trade name) manufactured by Ciba Specialty Chemicals, 0.05 part) and they were polymerized by UV irradiation to give a viscose liquid having a polymerization rate of about 10 wt %, which is comprised of a composition containing polymers and monomers. Then, to the viscose liquid were added trimethylolpropane triacrylate (V#295 manufactured by OSAKA ORGANIC CHEMICAL INDUSTRY LTD., 0.15 part), a photopolymerization initiator (IRGACURE 184 (trade name) manufactured by Ciba Specialty Chemicals, 0.15 part), and a photopolymerization initiator (IRGACURE 651 (trade name) manufactured by Ciba Specialty Chemicals, 0.05 part) to give a photopolymerization composition. This photopolymerization composition was applied (cast) to a peeling-treated polyester film (thickness 75 μm) such that the thickness of the composition would be 200 μm. The composition was further covered with a polyester film (thickness 50 μm) as a cover, and exposed to UV at 2000 mJ/cm² from a UV lamp to allow photopolymerization to give a UV-cured acrylic adhesive sheet. The shear storage elastic modulus (G′) of the adhesive sheet at 25° C. was 0.4×10⁵(Pa), and the gel fraction was 25%. The level difference absorbability and resistance to foaming of the transparent adhesive sheet were evaluated. The results are shown in Table 1.

TABLE 1

| | | | gel | level | resistance | | |
|---|---|---|---|---|---|---|---|
| | compo- | (G′) | fraction | difference | to foaming | | |
| | sition | [Pa] | [%] | absorbability | PMMA | PC | PET |
| Ex. 1 | poly- | 0.2 × 10⁵ | 41 | ○ | ○ | ○ | ○ |
| | ether | | | | | | |
| Ex. 2 | poly- | 0.6 ×10⁵ | 65 | ○ | ○ | Δ | ○ |
| | ether | | | | | | |
| Comp. | acrylic | 2.3 × 10⁵ | 64 | x | ○ | ○ | ○ |
| Ex. 1 | | | | | | | |
| Comp. | acrylic | 0.4 × 10⁵ | 25 | ○ | Δ | x | Δ |
| Ex. 2 | | | | | | | |

From Table 1, it is clear that the transparent adhesive sheets of Examples have realized a transparent adhesive sheet extremely suitable for adhesion of adjacent layers in a front multi-layer structure part of flat panel display, since they have superior level difference absorbability, and do no develop bubbles in the adhesion surface to a plastic plate.

### INDUSTRIAL APPLICABILITY

Using the transparent adhesive sheet of the present invention, a high performance flat panel display that can protect the visual surface and permits superior visibility of displayed images can be realized.

This application is based on a patent application No. 2008-268890 filed in Japan, the contents of which are incorporated in full herein.

### EXPLANATION OF SYMBOLS

1 transparent adhesive sheet of the present invention
2 liquid crystal display panel
3 protective transparent plate
4 touch panel
5 black printed layer
100, 200 flat panel displays

1. A transparent adhesive sheet for flat panel display comprised of a cured product of a composition comprising the following components A-C, which shows a shear storage elastic modulus (G′) of not more than 1.0×10⁵ Pa at 25° C. and 1 Hz, and a gel fraction of not less than 40%:
A: a polyoxyalkylene based polymer having at least one alkenyl group in one molecule
B: a compound having an average of not less than 2 and less than 5 hydrosilyl groups in one molecule, and
C: a hydrosilylation catalyst.

2. The transparent adhesive sheet according to claim 1, for use in between two adjacent layers, at least one being a plastic plate or a plastic film, in a front multi-layer structure of the flat panel display.

3. The transparent adhesive sheet according to claim 2, wherein the two adjacent layers are a protective transparent plate comprised of a transparent plastic plate or a transparent plastic film and a display panel.

4. The transparent adhesive sheet according to claim 1, which shows a shear storage elastic modulus (G′) of not less than 0.1×10⁵ Pa at 25° C. and 1 Hz.

5. The transparent adhesive sheet according to claim 1, which shows a gel fraction of not more than 90%.

6. A flat panel display comprising a protective transparent plate comprised of a transparent plastic plate or transparent plastic film and a display panel, which are integrated by adhesion via the transparent adhesive sheet according to claim 1 disposed between the protective transparent plate and the display panel.

7. A flat panel display comprising a protective transparent plate comprised of a transparent plastic plate or transparent plastic film, a display panel and a touch panel inserted between the protective transparent plate and the display panel, wherein the transparent adhesive sheet according to claim 1 is disposed between a transparent plastic plate on the outermost layer of the touch panel and the protective transparent plate, and between a transparent plastic plate on the outermost layer of the other side of the touch panel and the display panel, whereby the protective transparent plate, the display panel and the touch panel are integrated by adhesion.
